(19) United States
(12) Patent Application Publication
(10) Pub. No.: US 2025/0295130 A1
(43) Pub. Date: Sep. 25, 2025

(54) MICROWAVE AND INFRARED HEATING SYSTEM AND METHOD FOR FRUIT AND VEGETABLE ENZYME DEACTIVATION

(71) Applicant: Deaktiv Inc., Seattle, WA (US)

(72) Inventor: Kevin Petersen, Maple Valley, WA (US)

(73) Assignee: Deaktiv Inc., Seattle, WA (US)

(21) Appl. No.: 19/083,279

(22) Filed: Mar. 18, 2025

Related U.S. Application Data
(60) Provisional application No. 63/566,975, filed on Mar. 19, 2024.

(51) Int. Cl. A23B 7/01; A23B 2/05; A23B 2/08; A23B 2/42

(52) U.S. Cl. CPC A23B 7/01; A23B 2/055; A23B 2/08; A23B 2/42; A23V 2300/24; A23V 2300/38

(57) ABSTRACT

A method for enzyme deactivation in raw produce involves a computer-controlled two-step heating process using microwave and infrared systems. Initially, a monolayer of raw produce is conveyed through a microwave oven, maintaining relative humidity below a threshold, to achieve a first average temperature. Subsequently, the produce is transferred to an infrared oven, where the relative humidity is kept above the threshold, resulting in a second average temperature that is equal to or greater than the first. The method ensures efficient enzyme deactivation by adjusting the respective depth of produce monolayers, the intensity and duration of microwave and infrared exposure, and controlling temperature and humidity levels during the heating process.

### CROSS-REFERENCE TO RELATED APPLICATIONS

This application claims the benefit of priority to U.S. Provisional Application No. 63/566,975 filed on Mar. 19, 2024, and U.S. Provisional Application No. 63/651,981 filed on May 25, 20024, which applications are incorporated herein by reference in their entireties.

### TECHNICAL FIELD

The present invention relates to food processing systems and methods, and more particularly, to a microwave and infrared heating system and method for enzyme deactivation in fruits and vegetables.

### BACKGROUND OF THE INVENTION

Fruits and vegetables are an essential part of a healthy diet, providing a rich source of vitamins, minerals, and fiber. However, they are also prone to enzymatic browning, a process that occurs when the polyphenol oxidase (PPO) enzyme in the fruits and vegetables is exposed to oxygen. This can lead to a decrease in the quality and nutritional value of the fruits and vegetables, softening of their textures as well as developing an unappealing brown color. This is a particular problem for raw fruits and vegetables that are cut or peeled, as this exposes more of the PPO enzyme to oxygen. Various methods have been used to prevent enzymatic browning, but these often involve the use of chemicals or can affect the taste and texture of the fruits and vegetables.

Accordingly, there is still a need in the art for new and better systems and methods to economically process fruits and vegetables (collectively, “produce”) to inhibit unwanted browning while preserving the produces' taste and texture. The present invention fulfills these needs and provides for further related advantages.

### BRIEF SUMMARY OF THE INVENTION

In brief, the present invention in an embodiment is directed to a method for enzyme deactivation in selected raw produce using an innovative two-stage computer-controlled microwave and infrared heating system. Initially, a monolayer of selected raw produce is conveyed through a microwave oven, while maintaining relative humidity below a threshold, to achieve a first average produce temperature. Subsequently, the produce is transferred (via a heated transition zone where the produce monolayer is further spread out to form a second much thinner monolayer) to an infrared oven, where the relative humidity is kept above the threshold, resulting in a second average produce temperature that is equal to or greater than the first. The method ensures efficient enzyme deactivation by adjusting the depth of the respective produce monolayers (that are being sequentially conveyed through the microwave and infrared ovens), and by controlling the level and duration of the microwave and infrared energy emitted (within the microwave and infrared ovens during processing), and by controlling temperature and humidity levels and heating duration within each oven.

Thus, and in an exemplary embodiment, the process achieves enzyme deactivation in raw produce by first conveying a monolayer of the produce through a microwave heating system. The system is configured to emit microwaves into a microwave oven while keeping the relative humidity below a certain level. This process results in microwave-heated produce with a specific average temperature. Subsequently, the produce is spread thinner into a monolayer and conveyed through an infrared heating system, which emits electromagnetic waves in the infrared range into a second oven. The relative humidity in the second oven is maintained above the threshold level, resulting in infrared-heated produce with a temperature that is about the same or higher than the initial temperature. The initial monolayer's depth may be up to 2.75 inches and generally at least five times greater than the second monolayer's depth. The threshold level of relative humidity is preferably about 60%. The total throughput of produce through each oven may be between 2,000 to 4,000 lbs./hr., and even up to 35,000 lbs./hr. in larger scale commercial embodiments.

The method may also include dispersing the first monolayer within a heated transition zone to form the second monolayer.

In some embodiments, the first average depth may be up to about ten times greater than the second average depth.

The process of conveying the first monolayer through the microwave heating system may use a belt conveyor system and may occur within a time frame of about 30 to 90 seconds.

The first average temperature of the produce may range from about 100° F. to about 170° F.

The second monolayer may be conveyed through the infrared heating system using a second belt conveyor system, also within about 30 to 90 seconds.

The second average temperature of the produce is preferably at least about 170° F.

The step of dispersing the first monolayer into the second monolayer within the transition zone preferably occurs in less than about 60 seconds.

These and other aspects of the present invention will become more readily apparent to those of ordinary skill in the art when reference is made to the following detailed description in view of the accompanying drawing.

### BRIEF DESCRIPTION OF THE DRAWINGS

The accompanying drawings illustrate certain preferred embodiments and related aspects of the present invention and, together with the detailed description, serve to explain the practice of the invention from the perspective of a person of ordinary skill in the art.

FIG. 1 is a block diagram of a sequential computer-controlled two-stage heating system that comprises a microwave oven, an infrared oven, and a controller connected to both, collectively configured to controllably heat produce (to thereby deactivate enzymes).

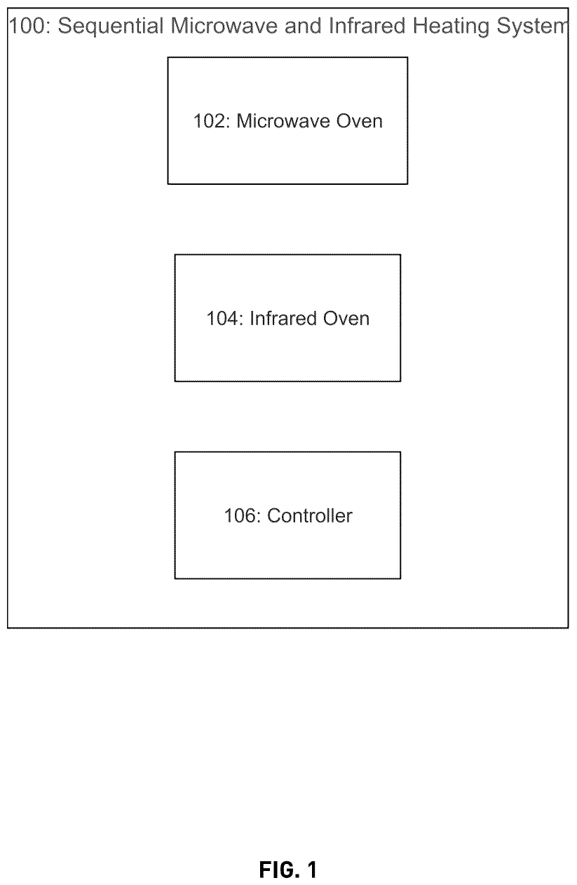

FIG. 2 is a flow chart that illustrates a series of process steps (i.e., labelled as process 200) for deactivating enzymes in raw fruits and vegetables (i.e., produce) using a controllable two-stage microwave and infrared heating system.

### DETAILED DESCRIPTION OF THE INVENTION

As disclosed herein, the present invention is directed to a computer-controlled two-stage system and method for deactivating enzymes (e.g., PPO) in raw fruits and vegetables (such as, for example, cut pieces of apples, apricots, avocados, bananas, beans, berries, cauliflower, corn, eggplants, grapes, lettuce, mangoes, melons, mushrooms, peaches, pears, and potatoes) using, in sequence, microwave and infrared heating. The innovative two-stage controllable system and multi-step method represents a significant innovation in the field of food safety—it combines cutting-edge technologies with practical application. Accordingly, this detailed description specifies various design and functional attributes of the invention, highlighting some of its key design features and technical specifications.

As used herein, the term “relative humidity” means the ratio of the amount of water vapor actually present in the air (of a specified volumetric environment such as an oven chamber) to the greatest amount of water vapor the air (of the same specified volumetric environment) could hold at the same temperature. It is expressed as a percentage and is calculated by dividing the partial pressure of water vapor by the saturation vapor pressure at the same temperature.

FIG. 100 illustrates a block diagram of a sequential computer-controlled two-stage microwave and infrared heating system (100) designed for enzyme deactivation in produce. The system comprises a microwave oven (102) and an infrared oven (104), both managed by a controller (106). This setup is intended to process fruits and vegetables by first moving them through the microwave oven, where electromagnetic waves in the microwave frequency range heat the produce to a first average temperature. During this phase, the relative humidity is maintained below a specified threshold, which may be set at 60%. This initial heating step is for preparing the produce for subsequent processing.

Following the microwave heating, the produce is transferred to the infrared oven (104), where it is subjected to electromagnetic waves in the infrared frequency range. Here, the relative humidity is maintained above the threshold, facilitating the heating of the produce to a second average temperature. This second temperature may range between about 40° F. and about 170° F., ensuring effective enzyme deactivation. The controller (106) plays a role in this system by independently managing both ovens to maintain the desired humidity levels and temperatures. It utilizes data from humidity and temperature sensors (not shown) to adjust the microwave and infrared emissions and processing speeds, ensuring precise control over the heating process.

The structural relationship between the components is straightforward, with the microwave oven (102) and infrared oven (104) positioned sequentially to allow continuous processing of the produce. The controller (106) is interconnected with both ovens, enabling real-time adjustments based on sensor feedback. This integration ensures that the system operates efficiently, achieving the desired enzyme deactivation while preserving the quality of the produce. The system's design reflects a focus on improving food processing efficiency through advanced thermal processing technologies, leveraging the rapid heating capabilities of microwaves and the precise surface heating of infrared technology.

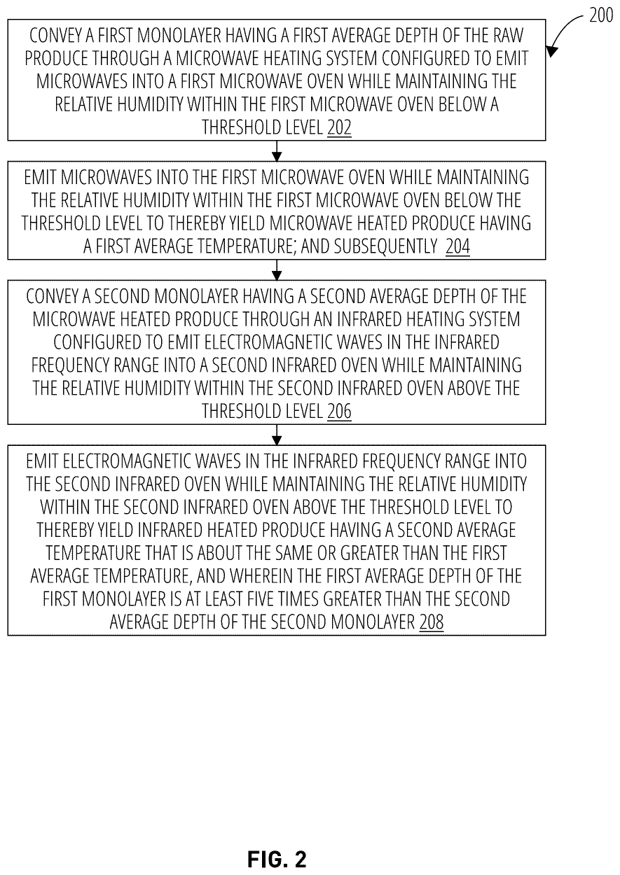

FIG. 2 is a flowchart illustrating a method for enzyme deactivation in produce through sequential microwave and infrared heating. Here, the present invention in an embodiment is directed to a multi-step process 200. In block 202, as illustrated, process 200 conveys a first monolayer having a first average depth (e.g., 2.5 inches) of the raw produce through a microwave heating system configured to emit microwaves into a first microwave oven while maintaining the relative humidity within the first microwave oven below a threshold level (e.g., 60% relative humidity). In block 204, process 100 emits microwaves into the first microwave oven while maintaining the relative humidity within the first microwave oven below the threshold level to thereby yield microwave heated produce having a first average temperature. Subsequently, and in block 206, process 200 conveys a second monolayer having a second average depth (e.g., between ˜0.125 to ˜0.5 inches, and preferably about ˜0.25 inches) of the microwave heated produce through an infrared heating system configured to emit electromagnetic waves in the infrared frequency range into a second infrared oven while maintaining the relative humidity within the second infrared oven above the threshold level. In block 208, process 200 emits electromagnetic waves in the infrared frequency range into the second infrared oven while maintaining the relative humidity within the second infrared oven above the threshold level to thereby yield infrared heated produce having a second average temperature that is about the same or greater than the first average temperature, and wherein the first average depth of the first monolayer is at least five times greater (and up to ten times greater) than the second average depth of the second monolayer.

Stated somewhat differently, the present invention in an exemplary embodiment is directed a sequential microwave and infrared heating method for enzyme deactivation of selected fruits or vegetables. The innovative method uses a computer-controlled two-stage microwave and infrared heating system and includes the steps of (1) providing a microwave oven having a first belt conveyor mechanism, where the first belt conveyor mechanism is configured to convey the selected fruits or vegetables through the microwave oven from a microwave oven inlet at one end and a microwave oven outlet at the opposite end, and where the microwave oven further includes one or more microwave emission assemblies configured to emit electromagnetic waves in the microwave frequency range within the microwave oven, (2) providing an infrared oven having a second belt conveyor mechanism, where the second belt conveyor mechanism is configured to convey the selected fruits or vegetables through the infrared oven from an infrared oven inlet at one end and an infrared oven outlet at the opposite end, and where the infrared oven further includes one or more infrared emission assemblies configured to emit electromagnetic waves in the infrared frequency range within the infrared oven, (3) conveying the selected fruits or vegetable through microwave oven (i) while the one or more microwave emission assemblies are emitting electromagnetic waves in the microwave frequency range within the microwave oven, and (ii) while maintaining the relative humidity below 60% within the microwave oven, to thereby heat the selected fruits and vegetables to a first average temperature, and (4) conveying the selected fruits or vegetable when at about the first average temperature through the infrared oven (i) while the one or more infrared emission assemblies are emitting electromagnetic waves in the infrared frequency range within the infrared oven, and (ii) while maintaining the relative humidity above 60% within the infrared oven.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing description, and all changes that come within the meaning and range of equivalency of the claims are to be embraced within their scope.

What is claimed is:

1. A method for enzyme deactivation in produce, comprising:
conveying a first monolayer having a first average depth of the produce through a microwave heating system configured to emit microwaves into a first microwave oven while maintaining the relative humidity within the first microwave oven below a threshold level;
emitting microwaves into the first microwave oven while maintaining the relative humidity within the first microwave oven below the threshold level to thereby yield microwave heated produce having a first average temperature; and subsequently
conveying a second monolayer having a second average depth of the microwave heated produce through an infrared heating system configured to emit electromagnetic waves in the infrared frequency range into a second infrared oven while maintaining the relative humidity within the second infrared oven above the threshold level; and
emitting electromagnetic waves in the infrared frequency range into the second infrared oven while maintaining the relative humidity within the second infrared oven above the threshold level to thereby yield infrared heated produce having a second average temperature that is about the same or greater than the first average temperature, and wherein the first average depth of the first monolayer is at least five times greater than the second average depth of the second monolayer.

2. The method of claim 1 wherein the threshold level of the relative humidity is about 60% relative humidity.

3. The method of claim 2 further comprising the step of dispersing the first monolayer within a heated transition zone to yield the second monolayer.

4. The method of claim 3 wherein the first average depth is about tens times greater than the second average depth.

5. The method of claim 3 wherein the step of conveying the first monolayer through the microwave heating system uses a first belt conveyor system and occurs within about 30 seconds to about 90 seconds.

6. The method of claim 5 wherein the first average temperature is between about 40° F. to about 170° F.

7. The method of claim 6 wherein the step of conveying the second monolayer through the infrared heating system uses a second belt conveyor system and occurs within about 30 seconds to about 90 seconds.

8. The method of claim 7 wherein the second average temperature is at least about 170° F.

9. The method of claim 8 wherein the step of dispersing the first monolayer into the second monolayer within the transition zone occurs within less than about 60 seconds.

10. A sequential microwave and infrared heating method for enzyme deactivation of selected fruits or vegetables, the method comprising the steps of:
providing a microwave oven having a first belt conveyor mechanism, wherein the first belt conveyor mechanism is configured to convey the selected fruits or vegetables through the microwave oven from a microwave oven inlet at one end and a microwave oven outlet at the opposite end, and wherein the microwave oven further comprises one or more microwave emission assemblies configured to emit electromagnetic waves in the microwave frequency range within the microwave oven;
providing an infrared oven having a second belt conveyor mechanism, wherein the second belt conveyor mechanism is configured to convey the selected fruits or vegetables through the infrared oven from an infrared oven inlet at one end and an infrared oven outlet at the opposite end, and wherein the infrared oven further comprises one or more infrared emission assemblies configured to emit electromagnetic waves in the infrared frequency range within the infrared oven;
conveying the selected fruits or vegetable through microwave oven (i) while the one or more microwave emission assemblies are emitting electromagnetic waves in the microwave frequency range within the microwave oven, and (ii) while maintaining the relative humidity below 60% within the microwave oven, to thereby heat the selected fruits and vegetables to a first average temperature;
conveying the selected fruits or vegetable when at about the first average temperature through the infrared oven (i) while the one or more infrared emission assemblies are emitting electromagnetic waves in the infrared frequency range within the infrared oven, and (ii) while maintaining the relative humidity above 60% within the infrared oven.
